(19) United States
(12) Patent Application Publication
(10) Pub. No.: US 2010/0097554 A1
(43) Pub. Date: Apr. 22, 2010

(54) LIQUID CRYSTAL DISPLAY PANEL AND MANUFACTURING METHOD THEREOF

(75) Inventors: Nobuyuki KOGANEZAWA, Chiba (JP); Susumu Sasaki, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/579,433

(22) Filed: Oct. 15, 2009

(30) Foreign Application Priority Data
Oct. 17, 2008 (JP) 2008-268345

(51) Int. Cl. G02F 1/1333; H01J 9/00

(52) U.S. Cl. 349/122; 445/24

(57) ABSTRACT

A liquid crystal display panel includes: a first glass substrate and a second glass substrate opposed to each other with a space therebetween; polarizing plates provided respectively on an outer surface of the first glass substrate and an outer surface of the second glass substrate except for a peripheral portion of the first glass substrate and a peripheral portion of the second glass substrate, the outer surface of the first glass substrate and the outer surface of the second glass substrate facing sides opposite to each other; and a water-resistant barrier film formed at the peripheral portion on the outer surface of at least one of the first glass substrate and the second glass substrate.

### CROSS-REFERENCE TO RELATED APPLICATION

The present application claims priority from Japanese application JP 2008-268345 filed on Oct. 17, 2008, the content of which is hereby incorporated by reference into this application.

### BACKGROUND OF THE INVENTION

1. Field of the Invention

The present invention relates to a liquid crystal display panel and a manufacturing method for the liquid crystal display panel.

2. Description of the Related Art

It is difficult to maintain glass in a curved state due to its vulnerability. Specifically, when there is a minute crack on a peripheral portion of the glass, curving the glass causes a tensile stress in a direction in which the crack is to expand. Then, moisture permeates through the crack to break bonding of molecules (SiO₂). As a result, the crack is enlarged. Therefore, it is desired to suppress enlargement of a crack even when a tensile stress is applied.

It should be noted that JP 06-144875 A discloses applying an adhesive with a moisture-proof effect, which is however insufficient in terms of a moisture-proof property.

### SUMMARY OF THE INVENTION

The present invention has an object to provide a liquid crystal display panel that may endure a tensile stress to be applied thereto.

(1) A liquid crystal display panel according to the present invention includes: a first glass substrate and a second glass substrate opposed to each other with a space therebetween; polarizing plates provided respectively on an outer surface of the first glass substrate and an outer surface of the second glass substrate except for a peripheral portion of the first glass substrate and a peripheral portion of the second glass substrate, the outer surface of the first glass substrate and the outer surface of the second glass substrate facing sides opposite to each other; and a water-resistant barrier film formed at the peripheral portion on the outer surface of at least one of the first glass substrate and the second glass substrate. According to the present invention, the water-resistant barrier film hinders moisture from permeating. Therefore, a bonding state of molecules (SiO₂) is maintained, and a crack is prevented from being enlarged. Accordingly, the liquid crystal display panel may endure the tensile stress applied thereto.

(2) The liquid crystal display panel according to Item (1) may further include a flexible wiring board provided at the peripheral portion on the outer surface of at least one of the first glass substrate and the second glass substrate.

(3) In the liquid crystal display panel according to Item (2), the water-resistant barrier film may be formed on an entire region of both the peripheral portion of the first glass substrate and the peripheral portion of the second glass substrate, except for an attachment portion with the flexible wiring board.

(4) In the liquid crystal display panel according to any one of Items (1) to (3), the water-resistant barrier film may be formed of poly(chloro-p-xylylene).

(5) A manufacturing method for a liquid crystal display panel according to the present invention includes: preparing a first glass substrate and a second glass substrate having outer surfaces on which polarizing plates covered with protective sheets are provided respectively except for a peripheral portion of the first glass substrate and a peripheral portion of the second glass substrate, the outer surface of the first glass substrate and the outer surface of the second glass substrate facing sides opposite to each other; forming a water-resistant barrier film on the first glass substrate, the second glass substrate, and the polarizing plates covered with the protective sheets; and peeling the protective sheets off the polarizing plates. According to the present invention, the water-resistant barrier film hinders moisture from permeating. Therefore, a bonding state of molecules (SiO₂) is maintained, and a crack is prevented from being enlarged. Accordingly, the liquid crystal display panel may endure the tensile stress applied thereto.

(6) In the manufacturing method for a liquid crystal display panel according to Item (5): the preparing a first glass substrate and a second glass substrate may include providing a flexible wiring board at the peripheral portion on the outer surface of at least one of the first glass substrate and the second glass substrate; and the forming a water-resistant barrier film may include forming the water-resistant barrier film on an entire region of both the peripheral portion of the first glass substrate and the peripheral portion of the second glass substrate, except for an attachment portion with the flexible wiring board.

(7) In the manufacturing method for a liquid crystal display panel according to Item (5) or (6), the water-resistant barrier film may be formed of poly(chloro-p-xylylene).

### BRIEF DESCRIPTION OF THE DRAWINGS

In the accompanying drawings:

FIG. 1 is a view illustrating a manufacturing method for a liquid crystal display panel according to an embodiment of the present invention;

FIG. 2 is a cross sectional view of a first glass substrate, a second glass substrate, and the like illustrated in FIG. 1, which is taken along the line II-II;

FIG. 3 is a view illustrating the manufacturing method for the liquid crystal display panel according to the embodiment of the present invention;

FIG. 4 is a view illustrating the manufacturing method for the liquid crystal display panel according to the embodiment of the present invention;

FIG. 5 is a view illustrating the manufacturing method for the liquid crystal display panel according to the embodiment of the present invention;

FIG. 6 is a view illustrating the manufacturing method for the liquid crystal display panel according to the embodiment of the present invention; and

FIG. 7 is a view illustrating the liquid crystal display panel in use according to the embodiment of the present invention.

### DETAILED DESCRIPTION OF THE INVENTION

Hereinafter, an embodiment of the present invention is described with reference to the accompanying drawings.

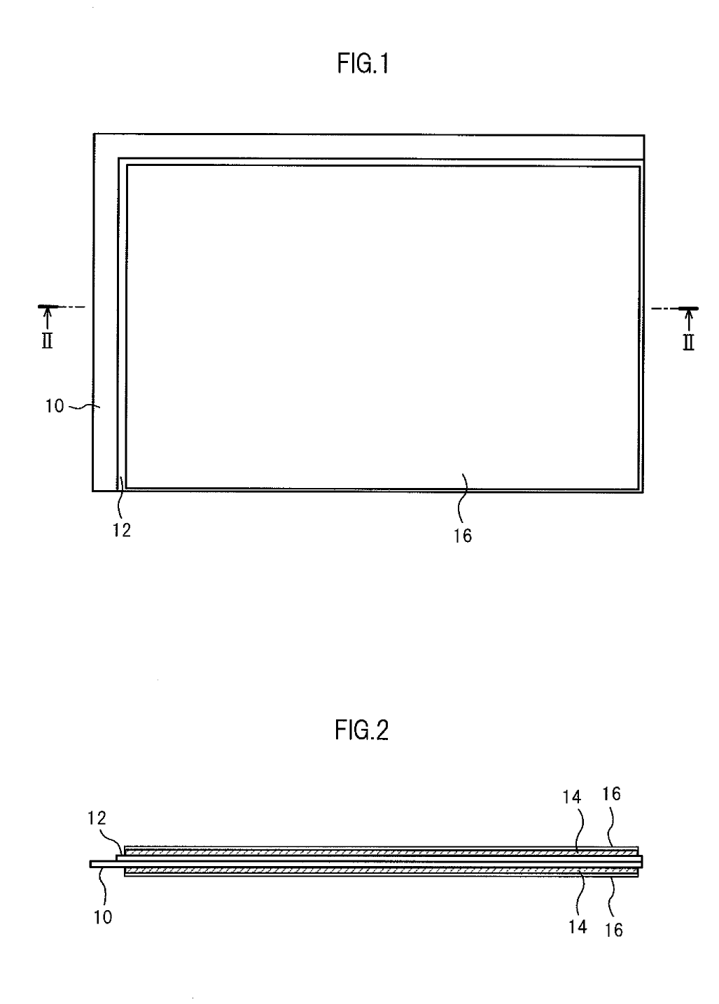

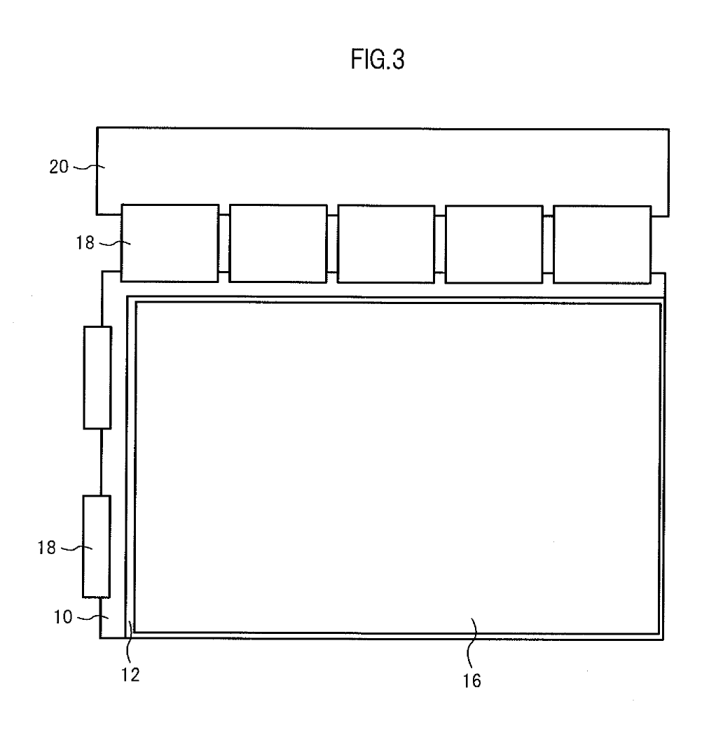

FIGS. 1 to 6 are views each illustrating a manufacturing method for a liquid crystal display panel according to the embodiment of the present invention. FIG. 2 is a cross sectional view of a first glass substrate, a second glass substrate, and the like illustrated in FIG. 1, which is taken along the line II-II.

As illustrated in FIG. 1, a first glass substrate 10 and a second glass substrate 12 are prepared. Liquid crystal (not shown) is held between the first glass substrate 10 and the second glass substrate 12 and is sealed with a seal material (not shown). A driving system for the liquid crystal may be any one of an in plane switching (IPS) system, a twisted nematic (TN) system, a vertical alignment (VA) system, and the like. An electrode and wiring corresponding to the driving system are formed on at least one of the first glass substrate 10 and the second glass substrate 12.

Polarizing plates 14 are provided respectively on outer surfaces of the first glass substrate 10 and the second glass substrate 12 except for peripheral portions thereof, the outer surface of the first glass substrate 10 and the outer surface of the second glass substrate 12 facing sides opposite to each other. Specifically, the polarizing plates 14 are not provided on end surfaces of the first glass substrate 10 and the second glass substrate 12. The polarizing plates 14 (specifically, surfaces thereof facing sides opposite to the first glass substrate 10 and the second glass substrate 12) are covered with protective sheets 16.

As illustrated in FIG. 3, flexible wiring boards 18 are attached to a peripheral portion on the outer surface of at least one of the first glass substrate 10 and the second glass substrate 12 (for example, first glass substrate 10). A wiring pattern (not shown) is formed in each of the flexible wiring boards 18 and is electrically connected to a terminal (not shown) which is formed on the first glass substrate 10. Further, a circuit board 20 may be attached to the flexible wiring boards 18.

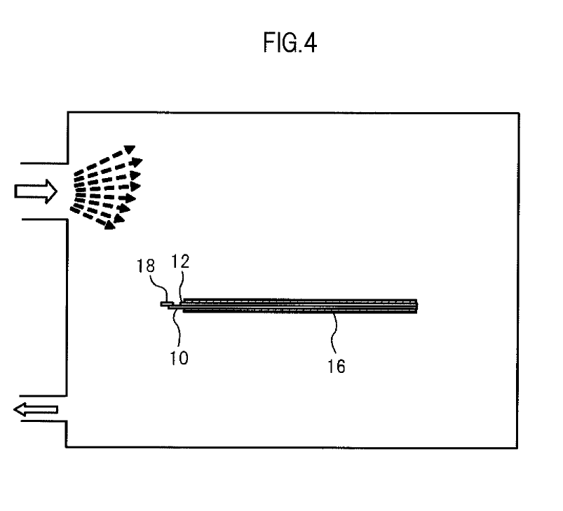

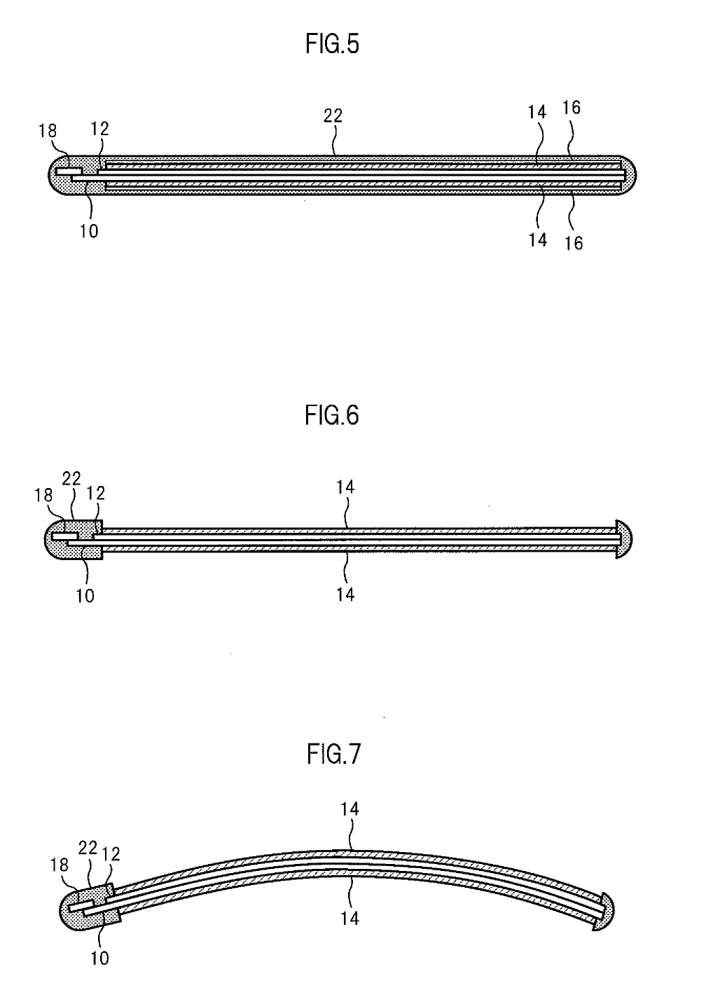

As illustrated in FIG. 4, a water-resistant barrier film 22 (see FIG. 5) is formed on the first glass substrate 10, the second glass substrate 12, and the polarizing plates 14 covered with the protective sheets 16 (see FIG. 2). The water-resistant barrier film 22 is a film that does not allow water molecules to pass therethrough, and may be formed of, for example, poly(chloro-p-xylylene). The water-resistant barrier film 22 may be formed by chemical vapor deposition (CVD).

As illustrated in FIG. 5, the water-resistant barrier film 22 is formed over and/or on an entire region of both the peripheral portions of the first glass substrate 10 and the second glass substrate 12, except for attachment portions between the first glass substrate 10 and the flexible wiring boards 18. The water-resistant barrier film 22 is formed also on the end surfaces of the first glass substrate and the second glass substrate 12. In addition, the water-resistant barrier film 22 is formed also on the protective sheets 16, the flexible wiring boards 18, and the circuit board 20 (see FIG. 3).

As illustrated in FIG. 6, the protective sheets 16 (see FIG. 5) are peeled off the polarizing plates 14, to thereby expose the polarizing plates 14. Parts of the water-resistant barrier film 22 located on the protective sheets 16 are removed together with the protective sheets 16. Another part of the water-resistant barrier film 22 remains over and/or on the entire region of both the peripheral portions of the first glass substrate 10 and the second glass substrate 12, except for the attachment portions between the first glass substrate 10 and the flexible wiring boards 18. In other words, end portions of the first glass substrate 10 and the second glass substrate 12 are covered with the water-resistant barrier film 22. In addition, the water-resistant barrier film 22 remains on the protective sheets 16, the flexible wiring boards 18, and the circuit board 20 (see FIG. 3).

The manufacturing method for the liquid crystal display panel of this embodiment includes steps of a known manufacturing method for a liquid crystal display panel.

The liquid crystal display panel manufactured through the method including the above-mentioned process includes the first glass substrate 10 and the second glass substrate 12 which are opposed to each other with a space therebetween. The liquid crystal is sealed between the first glass substrate 10 and the second glass substrate 12. The polarizing plates 14 are provided respectively on the outer surfaces of the first glass substrate 10 and the second glass substrate 12 except for the peripheral portions thereof, the outer surface of the first glass substrate 10 and the outer surface of the second glass substrate 12 facing sides opposite to each other. The water-resistant barrier film 22 is formed at the peripheral portion on the outer surface of at least one of the first glass substrate 10 and the second glass substrate 12. The water-resistant barrier film 22 is formed over and/or on the entire region of both the peripheral portions of the first glass substrate 10 and the second glass substrate 12, except for the attachment portions between the first glass substrate 10 and the flexible wiring boards 18. The water-resistant barrier film 22 is formed of poly (chloro-p-xylylene). The flexible wiring boards 18 are provided at the peripheral portion on the outer surface of at least one of the first glass substrate 10 and the second glass substrate 12.

According to the liquid crystal display panel of this embodiment, the water-resistant barrier film 22 hinders moisture from permeating. Therefore, a bonding state of molecules (SiO₂) is maintained, and even if a crack is formed, the crack is prevented from being enlarged. Other details of the liquid crystal display panel of this embodiment correspond to the structure of a known liquid crystal display panel.

FIG. 7 is a view illustrating the liquid crystal display panel in use according to the embodiment of the present invention. The liquid crystal display panel of this embodiment has the above-mentioned feature. Therefore, even when the first glass substrate 10 and the second glass substrate 12 are curved as illustrated in FIG. 7, the liquid crystal display panel may endure a tensile stress applied thereto. As a result, a crack is less likely to occur.

The present invention is not limited to the above-mentioned embodiment, and may be variously modified. For example, the structure of the embodiment described above may be replaced by a structure that is substantially the same as that of the embodiment, a structure that provides the same action and effect as those of the embodiment, or a structure that may achieve the same object as that of the embodiment.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display panel, comprising:
a first glass substrate and a second glass substrate opposed to each other with a space therebetween;
polarizing plates provided respectively on an outer surface of the first glass substrate and an outer surface of the second glass substrate except for a peripheral portion of the first glass substrate and a peripheral portion of the second glass substrate, the outer surface of the first glass substrate and the outer surface of the second glass substrate facing sides opposite to each other; and
a water-resistant barrier film formed at the peripheral portion on the outer surface of at least one of the first glass substrate and the second glass substrate.

2. The liquid crystal display panel according to claim 1, further comprising a flexible wiring board provided at the peripheral portion on the outer surface of at least one of the first glass substrate and the second glass substrate.

3. The liquid crystal display panel according to claim 2, wherein the water-resistant barrier film is formed on an entire region of both the peripheral portion of the first glass substrate and the peripheral portion of the second glass substrate, except for an attachment portion with the flexible wiring board.

4. The liquid crystal display panel according to claim 1, wherein the water-resistant barrier film is formed of poly(chloro-p-xylylene).

5. The liquid crystal display panel according to claim 2, wherein the water-resistant barrier film is formed of poly(chloro-p-xylylene).

6. The liquid crystal display panel according to claim 3, wherein the water-resistant barrier film is formed of poly(chloro-p-xylylene).

7. A manufacturing method for a liquid crystal display panel, comprising:
preparing a first glass substrate and a second glass substrate having outer surfaces on which polarizing plates covered with protective sheets are provided respectively except for a peripheral portion of the first glass substrate and a peripheral portion of the second glass substrate, the outer surface of the first glass substrate and the outer surface of the second glass substrate facing sides opposite to each other;
forming a water-resistant barrier film on the first glass substrate, the second glass substrate, and the polarizing plates covered with the protective sheets; and
peeling the protective sheets off the polarizing plates.

8. The manufacturing method for a liquid crystal display panel according to claim 7, wherein:
the preparing a first glass substrate and a second glass substrate includes providing a flexible wiring board at the peripheral portion on the outer surface of at least one of the first glass substrate and the second glass substrate; and
the forming a water-resistant barrier film includes forming the water-resistant barrier film on an entire region of both the peripheral portion of the first glass substrate and the peripheral portion of the second glass substrate, except for an attachment portion with the flexible wiring board.

9. The manufacturing method for a liquid crystal display panel according to claim 7, wherein the water-resistant barrier film is formed of poly(chloro-p-xylylene).

10. The manufacturing method for a liquid crystal display panel according to claim 8, wherein the water-resistant barrier film is formed of poly(chloro-p-xylylene).
